(19) United States
(12) Patent Application Publication
(10) Pub. No.: US 2016/0252063 A1
(43) Pub. Date: Sep. 1, 2016

(54) Variable Drive For Liquified Natural Gas Pump

(71) Applicant: AVL Powertrain Engineering, Inc., Plymouth, MI (US)

(72) Inventors: Gregory Mordukhovich, Bloomfield Hills, MI (US); Michael KOZAN, Canton, MI (US)

(21) Appl. No.: 15/051,114

(22) Filed: Feb. 23, 2016

Related U.S. Application Data
(60) Provisional application No. 62/121,768, filed on Feb. 27, 2015.

(51) Int. Cl. F02M 59/20; F04D 27/00; F04D 25/02

(52) U.S. Cl. CPC F02M 59/20; F04D 25/028; F04D 27/004

(57) ABSTRACT

A fuel pump assembly including a fuel pump and a variable drive mechanism is provided. The fuel pump has a pump input shaft rotatably coupled to an impeller. The variable drive mechanism has a drive input shaft that receives torque from the engine of a vehicle and a drive output shaft that is rotatably coupled to the pump input shaft. The variable drive mechanism further comprises a planetary gearset interconnecting the drive input shaft and the drive output shaft. The planetary gearset has a variable gear ratio that varies rotational speed of the drive output shaft and therefore the pump input shaft relative to the rotational speed of the drive input shaft. Accordingly, the rotational speed of the pump input shaft and thus the volume flowrate of the fuel pump can be adjusted for any given engine speed to minimize pump related losses.

### CROSS-REFERENCE TO RELATED APPLICATIONS

This application claims the benefit of U.S. Provisional Application No. 62/121,768, filed on Feb. 27, 2015. The entire disclosure of the application referenced above is incorporated herein by reference.

### FIELD

The present disclosure generally relates to fuel pump assemblies, and more specifically, to variable drive mechanisms that connect to and drive a pump input shaft of a liquefied natural gas pump.

### BACKGROUND

This section provides background information related to the present disclosure which is not necessarily prior art.

Liquefied natural gas pumps are utilized in vehicles having engines that are powered by liquefied natural gas (LNG). As a fuel, liquefied natural gas is a cleaner alternative to fossil fuels since combustion of liquefied natural gas produces fewer pollutants and other harmful emissions. Conventional liquefied natural gas pumps are non-variable positive displacement pumps meaning the volume flowrate of the liquefied natural gas pump is fixed for a given pump speed. Such pumps generally have an impeller that is mounted on a pump input shaft. The pump input shaft is driven directly or indirectly by the engine. Accordingly, the pump speed and thus the volume flowrate of conventional liquefied natural gas pumps are dependent on the rotational speed of the engine. As a result, there are times when the volume flowrate of the liquefied natural gas pump exceeds the fuel requirements of the engine. This is particularly true in heavy duty truck applications when the engine and thus the liquefied natural gas pump are operating at high rotational speeds. Under these circumstances, pump-related losses, including friction losses and viscous losses, are unnecessarily high and contribute to reduced fuel economy.

Current liquefied natural gas pumps are designed to be installed within cryogenic vessel fuel tanks in order to minimize heat leak and to limit external exposure of cryogenic pump components. As a result, such liquefied natural gas pumps are highly specialized for operation at the low temperatures associated with a cryogenic environment. Accordingly, the adoption of existing variable pump designs found in other applications would require extensive re-design work and would result in high costs due to the specific requirements of liquefied natural gas pumps. Accordingly, conventional, non-variable liquefied natural gas pumps remain in use despite the associated pump-related losses and reduced vehicle efficiencies.

### SUMMARY

This section provides a general summary of the disclosure, and is not a comprehensive disclosure of its full scope or all of its features.

The subject disclosure provides an efficiency improving solution by providing a fuel pump assembly that includes a fuel pump and a variable drive mechanism. The fuel pump has a pump input shaft that is rotatably coupled to an impeller. The variable drive mechanism includes a drive input shaft that receives torque from the engine of the vehicle and a drive output shaft that is rotatably coupled to the pump input shaft of the fuel pump. A planetary gearset interconnects the drive input shaft and the drive output shaft to define a first torque flow path. The planetary gearset has a variable gear ratio that varies the rotational speed of the drive output shaft and thus the pump input shaft relative to a rotational speed of the drive input shaft and the engine.

Advantageously, the variable gear ratio of the variable drive mechanism allows the input shaft of the fuel pump to be driven at different rotational speeds for any given rotational speed of the drive input shaft (i.e. for any given engine speed). Accordingly, the pump speed and thus the volume flowrate of the fuel pump are no longer dependent on engine speed alone. As a result, the pump speed of non-variable fuel pumps, such as a non-variable positive displacement liquefied natural gas pump, may be adjusted using the variable drive mechanism to minimize pump-related losses and increase efficiency. At the same time, the use of the variable drive mechanism to control pump speed and volume flowrate avoids the need to completely redesign fuel pumps for use in liquefied natural gas power vehicles.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an environmental side view of an exemplary liquefied natural gas pump assembly constructed in accordance with the subject disclosure where liquefied natural gas pump assembly is disposed in the fuel tank of a vehicle;

FIG. 2 is a schematic view of the exemplary liquefied natural gas pump assembly shown in FIG. 1 where the variable drive mechanism includes a planetary gearset that is connected to a clutch;

FIG. 3 is a schematic view of another exemplary liquefied natural gas pump assembly shown in FIG. 1 where the variable drive mechanism includes a planetary gearset that is connected to a clutch;

FIG. 4 is a schematic view of another exemplary liquefied natural gas pump assembly constructed in accordance with the subject disclosure where the variable drive mechanism includes a planetary gearset that is connected to an electric motor;

FIG. 5 is a schematic view of another exemplary liquefied natural gas pump assembly constructed in accordance with the subject disclosure where the variable drive mechanism includes a planetary gearset that is connected to a disc brake; and

FIG. 6 is a schematic view of another exemplary liquefied natural gas pump assembly constructed in accordance with the subject disclosure where the variable drive mechanism includes a planetary gearset that is connected to a band brake.

### DETAILED DESCRIPTION

Referring to the Figures, wherein like numerals indicate corresponding parts throughout the several views, a liquefied natural gas pump assembly 20 is disclosed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this application, the term module may be replaced with the terms electronic circuit or controller. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip. The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

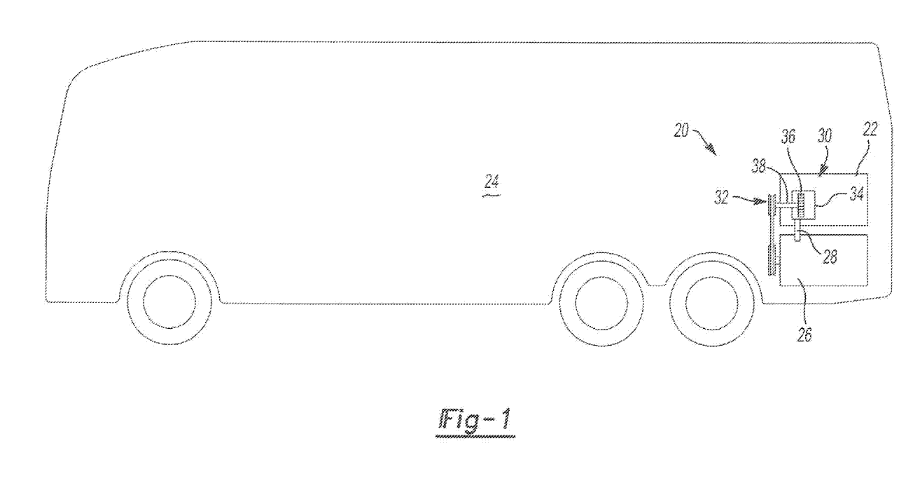

Referring to FIG. 1, a liquefied natural gas pump assembly 20 is illustrated submersed in liquefied natural gas (LNG) contained within a fuel tank 22. Such systems are commonly referred to as in-tank pumps. The fuel tank 22 is installed in a vehicle 24, which includes an engine 26. The liquefied natural gas in the fuel tank 22 is pumped from the fuel tank 22 and supplied to the engine 26 for combustion in response to operation of the liquefied natural gas pump assembly 20. The liquefied natural gas is communicated from the liquefied natural gas pump assembly 20 to the engine 26 via one or more fuel lines 28 extending between the liquefied natural gas pump assembly 20 and the engine 26. The liquefied natural gas pump assembly 20 generally includes a liquefied natural gas pump 30 (i.e. a fuel pump 30) coupled to a variable drive mechanism 32 (which may alternatively be referred to as a variable drive apparatus). The liquefied natural gas pump 30 may be a non-variable, positive displacement pump. Accordingly, the liquefied natural gas pump 30 has a fixed volume flowrate for any given pump speed. The liquefied natural gas pump 30 may generally include a housing 34 and an impeller 36 disposed within the housing 34. A pump input shaft 38 extends from the housing 34 and is rotatably coupled to the impeller 36 such that rotation of the pump input shaft 38 rotates the impeller 36, which pumps fluid through the housing 34 of the liquefied natural gas pump 30. The fuel tank 22 containing the liquefied natural gas may more specifically be a cryogenic vessel to minimize heat leak from the liquefied natural gas. Accordingly, the liquefied natural gas pump 30 may be disposed within this cryogenic vessel to further minimize heat sink and to limit external exposure of cryogenic parts.

The variable drive mechanism 32 allows for adjustment of pump speed such that pump speed is not solely dependent upon engine speed. This provides variable pump speed control of conventional non-variable, positive displacement pumps without requiring substantial modifications to the structure of the liquefied natural gas pump 30 itself. Such adjustability is advantageous because pump related losses can be minimized at high engine operating speeds. Accordingly, the overall fuel efficiency of the vehicle 24 is improved. Thus, it should be appreciated that the disclosed liquefied natural gas pump assembly 20 may find utility when installed in a variety of liquefied natural gas fueled vehicle applications, including without limitation, automobile, light truck, and heavy truck applications.

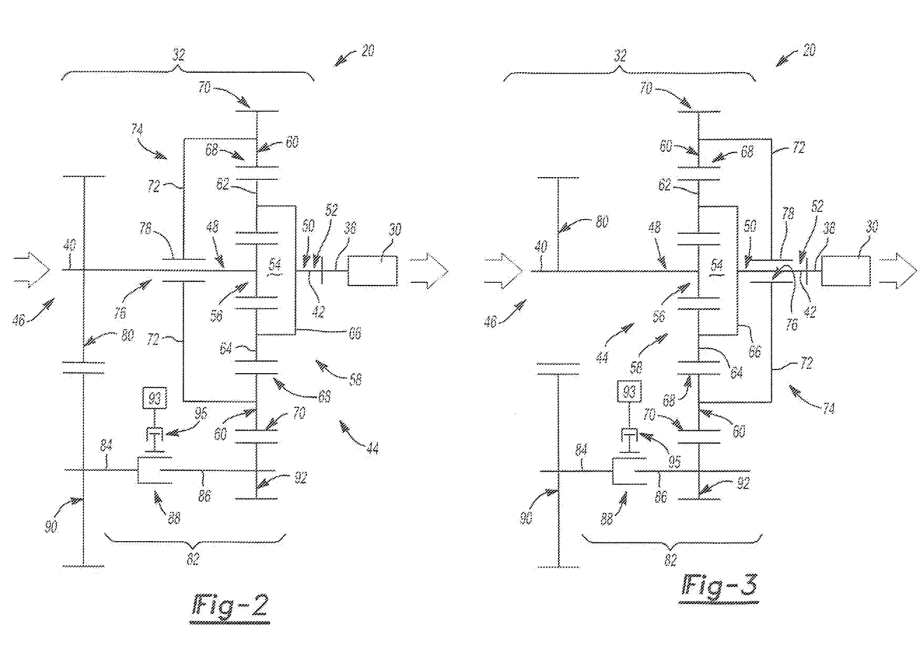

As shown in FIG. 2, the liquefied natural gas pump 30 is rotatably coupled to the variable drive mechanism 32. The variable drive mechanism 32 includes a drive input shaft 40 that receives torque from the engine 26 of the vehicle 24 and a drive output shaft 42 that is rotatably coupled to the pump input shaft 38. The variable drive mechanism 32 also includes a planetary gearset 44 interconnecting the drive input shaft 40 and the drive output shaft 42 of the variable drive mechanism 32. Accordingly, the planetary gearset 44 provides a first torque flow path through the variable drive mechanism 32. Additionally, the planetary gearset 44 operates to vary a rotational speed of the drive output shaft 42 and thus the pump input shaft 38 relative to a rotational speed of the drive input shaft 40 and thus the engine 26. This second function of the planetary gearset 44 will be discussed in further detail below.

The drive input shaft 40 of the variable drive mechanism 32 extends between a first end 46 that receives torque from the engine 26 of the vehicle 24 and a second end 48 that is opposite the first end 46 of the drive input shaft 40. Accordingly, the second end 48 of the drive input shaft 40 is disposed adjacent to the planetary gearset 44. The drive output shaft 42 extends between a first end 50 that is disposed adjacent to the planetary gearset 44 and a second end 52 that is adjacent and rotatably coupled to the pump input shaft 38. The drive input shaft 40 and the drive output shaft 42 are longitudinally spaced from one another and may or may not be aligned. Accordingly, a longitudinal gap 54 is formed between the second end 48 of the drive input shaft 40 and the first end 50 of the drive output shaft 42.

The planetary gearset 44 of the variable drive mechanism 32 includes a sun gear 56, a plurality of pinion gears 58, and a ring gear 60. The sun gear 56 is rotatably coupled to and carried on the drive input shaft 40 adjacent the second end 48 of the drive input shaft 40. The plurality of pinion gears 58 are disposed radially about the sun gear 56 and are thus arranged in meshing engagement with the sun gear 56. Although the plurality of pinion gears 58 may include any number of pinion gears, the configurations illustrated in FIGS. 2-6 include four pinion gears 58. Of the four pinion gears 58, only two, a first pinion gear 62 and a second pinion gear 64 are illustrated in FIGS. 2-6 because the other two pinion gears (not shown) are outside the plane of the drawing sheets, where one is located in front of the sun gear 56 and the other is located behind the sun gear 56 from the perspective of the viewer. Each pinion gear of the plurality of pinion gears 58 is supported on a pinion gear carrier 66 that is rotatably coupled to the drive output shaft 42 adjacent the first end 50 of the drive output shaft 42. The ring gear 60 is disposed radially outwardly of the plurality of pinion gears 58 and extends annularly about the sun gear 56 and the plurality of pinion gears 58. The ring gear 60 is thus arranged in meshing engagement with the plurality of pinion gears 58. The ring gear 60 illustrated in FIG. 2 presents a plurality of internal gear teeth 68 that face inwardly toward the plurality of pinion gears 58 and a plurality of external gear teeth 70 that face outwardly. The plurality of pinion gears 58 are thus more particularly arranged in meshing engagement with the plurality of internal gear teeth 68 of the ring gear 60. The ring gear 60 is supported on a ring gear carrier 72 that rotates freely and independent of the drive input shaft 40 and the drive output shaft 42. The ring gear carrier 72 is generally cylindrical and has a partially closed end 74 that defines a pass-through opening 76 that receives one of the drive input shaft 40 and the drive output shaft 42. A bearing assembly 78 may be disposed in the pass-through opening 76 between the ring gear carrier 72 and the drive input shaft 40 or the drive output shaft 42. In FIG. 2, the drive input shaft 40 is shown passing through the pass-through opening 76 in the ring gear carrier 72 such that the ring gear carrier 72 is supported on the drive input shaft 40 via the bearing assembly 78. Alternatively, the drive output shaft 42 may pass through the pass-through opening 76 in the ring gear carrier 72 as shown in FIG. 3 such that the ring gear carrier 72 is supported on the drive output shaft 42 via the bearing assembly 78. It should also be appreciated that the ring gear carrier 72 may be a separate part that is rotatably coupled to the ring gear 60 or may alternatively be integral with the ring gear 60.

Referring to FIGS. 2 and 3, the variable drive mechanism 32 includes a drive input gear 80 that is rotatably coupled to and carried on the drive input shaft 40 at or near the first end 46 of the drive input shaft 40. A clutch shaft 82 extends parallel to the drive input shaft 40 such that the clutch shaft 82 and the drive input shaft 40 are transversely spaced from one another. The clutch shaft 82 is generally broken into two segments including an input segment 84 and an output segment 86 that is opposite the input segment 84. A clutch 88 is disposed between and interconnects the input segment 84 and the output segment 86 of the clutch shaft 82. Accordingly, the clutch 88 selectably couples rotation of the input segment 84 of the clutch shaft 82 with rotation of the output segment 86 of the clutch shaft 82. It should be appreciated that the clutch 88 may be, without limitation, a wet frictional clutch 88, a dry friction clutch 88, or a viscous clutch 88 and may be constructed of one or more known components including, without limitation, a clutch housing, clutch plates, actuators, friction surfaces, and fluid moving vanes.

A clutch input gear 90 is rotatably coupled to and carried on the input segment 84 of the clutch shaft 82. The clutch input gear 90 is arranged in meshing engagement with the drive input gear 80 such that rotation of the drive input shaft 40 drives rotation of the input segment 84 of the clutch shaft 82 via the drive input gear 80 and the clutch input gear 90. A clutch output gear 92 is rotatably coupled to and carried on the output segment 86 of the clutch shaft 82. The clutch output gear 92 is arranged in meshing engagement with the ring gear 60, and more particularly, with the plurality of external gear teeth 70 of the ring gear 60. Accordingly, rotation of the output segment 86 of the clutch shaft 82 drives rotation of the ring gear 60 via the clutch output gear 92. As a result, a second torque flow path between said drive input shaft 40 and said planetary gearset 44 is created extending through the drive input gear 80, the clutch input gear 90, the clutch shaft 82, the clutch 88, and the clutch output gear 92. The variable drive mechanism 32 may further include a clutch control module 93 operably connected to a clutch actuator 95. The clutch control module 93 controls actuation of the clutch actuator 95 and actuation of the clutch actuator 95 applies pressure on the clutch 88 causing the clutch 88 to engage the output segment 86 of the clutch output shaft 82. Together, the clutch control module 93 and the clutch actuator 95 control clutch slip to vary the amount of torque that is transmitted through the clutch 88 to the output segment 86 of the clutch output shaft 82. In this way, operational control of the clutch 88 is used to vary the rotational speed of the drive output shaft 42 and thus the pump input shaft 38 relative to the rotational speed of the drive input shaft 40, therefore providing the planetary gearset 44 with a variable gear ratio. Accordingly, the rotational speed of the pump input shaft 38 can be varied for any given engine speed. It should also be appreciated that in addition to driving rotation of the ring gear 60, the second torque flow path may brake or slow rotation of the ring gear 60 depending on gear ratios chosen for the drive input gear 80 and the clutch input gear 90 versus the clutch output gear 92 and the ring gear 60.

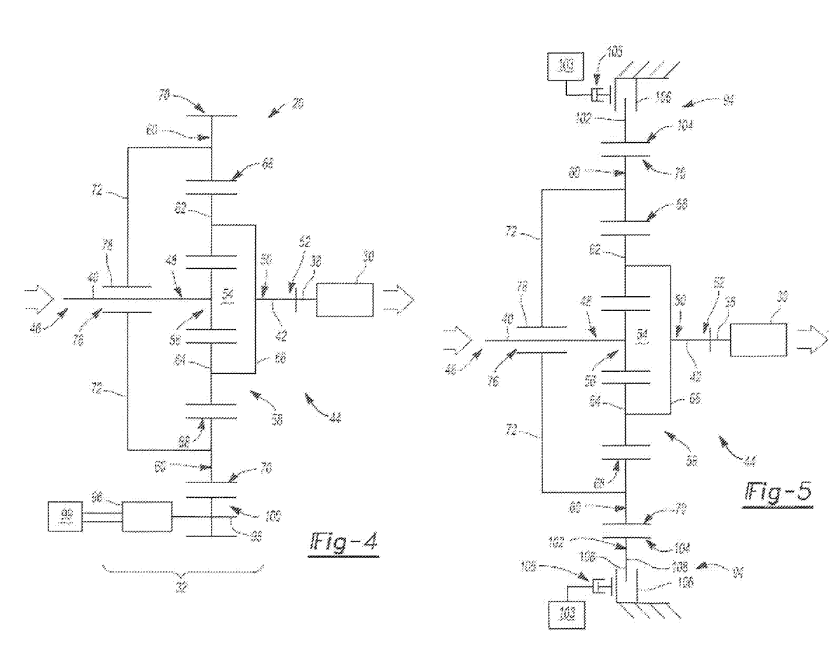

In FIG. 4, the clutch 88, clutch shaft 82, and associated structure of the second torque flow path shown in FIGS. 2 and 3 is replaced by an electric motor 96 in the liquefied natural gas pump assembly 20. As shown in FIG. 4, the variable drive mechanism 32 includes an electric motor 96 disposed adjacent the planetary gearset 44. The electric motor 96 has an electric motor output shaft 98 that rotates in response to operation of the electric motor 96. Operation of the electric motor 96 is controlled by a power supply 99 that is electrically connected to the electric motor 96. The power supply 99 may vary the electric current and/or voltage supplied to the electric motor 96 to provide on/off and speed control of the electric motor 96. An electric motor output gear 100 is rotatably coupled to and carried on the electric motor output shaft 98. The electric motor output gear 100 is arranged in meshing engagement with the ring gear 60, and more particularly, with the plurality of external gear teeth 70 of the ring gear 60. Accordingly, the electric motor 96 drives rotation of the electric motor output shaft 98 and thus the electric motor output gear 100 when the electric motor 96 is supplied with electric current. It should be appreciated that the electric motor 96 may be, without limitation, a direct current (DC) electric motor or an alternating current (AC) electric motor, and the electric motor 96 may be constructed of one or more known components including, without limitation, a housing, electrical windings, a permanent magnet, a rotor, a stator, an armature, a pole piece, an electromagnet, an air-gap, and a commutator.

Rotation of the electric motor output gear 100 drives rotation of the ring gear 60 or alternatively brakes rotation of the ring gear 60 depending on gear ratios between the electric motor output gear 100 and the ring gear 60. In this way, operational control of the rotational speed of the electric motor 96 is used to vary the rotational speed of the drive output shaft 42 and thus the pump input shaft 38 relative to the rotational speed of the drive input shaft 40. Accordingly, the rotational speeds of the pump input shaft 38 can be varied for any given engine speed.

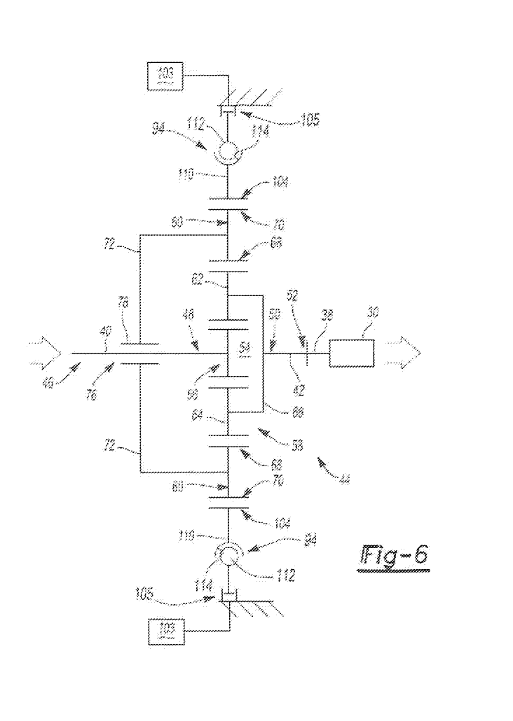

In FIGS. 5 and 6, the electric motor 96 of FIG. 4 is replaced by a brake 94. As shown in FIGS. 5 and 6, the variable drive mechanism 32 includes a brake 94 that is disposed adjacent the planetary gearset 44. Generally, a brake gear 104 is rotatably coupled to the brake 94. The brake gear 104 is arranged in meshing engagement with the ring gear 60 and more particularly the plurality of external gear teeth 70 of the ring gear 60. The brake 94 is selectably applied to slow or stop rotation of the brake gear 104 and thus the ring gear 60 of the planetary gearset 44. The variable drive mechanism 32 may include a brake control module 103 that is operably connected to a brake actuator 105. The brake control module 103 controls actuation of the brake actuator 105 and actuation of the brake actuator 105 applies pressure on the brake 94 causing the brake 94 to engage. Together, the brake control module 103 and the brake actuator 105 control application of the brake 94 to vary the rotational speed of the drive output shaft 42 and thus the pump input shaft 38 relative to the rotational speed of the drive input shaft 40. Accordingly, the rotational speeds of the pump input shaft 38 can be varied at any given engine speed.

Although the brake 94 may take a variety of forms, the brake 94 could be, without limitation, a disc brake as shown in FIG. 5 or a band brake as shown in FIG. 6. With reference to FIG. 5, the brake gear 104 extends annularly about the ring gear 60 and the brake 94 is a disc brake including a caliper 106 and a rotor 102. The caliper 106 of the brake 94 is stationarily fixed with respect to the ring gear 60 of the planetary gearset 44. As such, the caliper 106 does not rotate with respect to the ring gear 60, the rotor 102, or the brake gear 104. The rotor 102 has a pair of opposing side faces 108 that are disc-shaped and the rotor 102 generally extends annularly about the brake gear 104. The rotor 102 is rotatably coupled to the brake gear 104 and therefore rotates with the brake gear 104. The caliper 106 frictionally engages the opposing side faces 108 of the rotor 102 to slow or stop rotation of the rotor 102 and therefore the brake gear 104 in response to actuation of the brake 94. It should be appreciated that the brake 94 may additionally have one or more known components including, without limitation, brake pads, a piston, a reservoir, and brake lines. Further, it should be appreciated that the brake gear 104 may alternatively be eliminated and the rotor 102 of the brake 94 may instead be rotatably coupled directly to the ring gear 60 of the planetary gear set.

With reference to FIG. 5, the brake gear 104 again extends annularly about the ring gear 60 and the brake 94 is a band brake including a drum 110 and a brake band 112. The drum 110 has an outer cylindrical surface 114 and is rotatably coupled to the brake gear 104. Thus, the drum 110 of the brake 94 rotates with the brake gear 104. The brake band 112 is disposed at least partially about and extends around the outer cylindrical surface 114 of the drum 110. The brake band 112 is stationarily fixed with respect to the ring gear 60 of the planetary gearset 44, the brake gear 104, and the drum 110. The brake band 112 frictionally engages outer cylindrical surface 114 of the drum 110 to slow or stop rotation of the drum 110 and thus the brake gear 104 in response to actuation of the brake 94. It should be appreciated that the brake 94 may additionally have one or more known components including, without limitation, a friction surface or brake pad, a piston, a stationary anchor pin, a movable brake pin, and a brake cable. Further, it should be appreciated that the brake gear 104 may alternatively be eliminated and the drum 110 of brake 94 may instead be rotatably coupled directly to the ring gear 60 of the planetary gearset 44.

Many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A fuel pump assembly comprising:
a fuel pump having a pump input shaft rotatably coupled to an impeller; and
a variable drive mechanism including a drive input shaft for receiving torque from an engine of a vehicle and a drive output shaft that is rotatably coupled to said pump input shaft, said variable drive mechanism having a planetary gearset interconnecting said drive input shaft and said drive output shaft to define a first torque flow path, said planetary gearset having a variable gear ratio that varies a rotational speed of said drive output shaft and said pump input shaft relative to a rotational speed of said drive input shaft and the engine.

2. The fuel pump assembly as set forth in claim 1 wherein said variable drive mechanism further comprises:
a clutch shaft spaced from said drive input shaft that includes an input segment that is rotatably coupled to said drive input shaft and an output segment opposite said input segment that is rotatably coupled to said planetary gearset; and
a clutch disposed between and selectively coupling said input segment and said output segment of said clutch shaft such that said input segment of said clutch shaft rotates with said output segment of said clutch shaft, said clutch shaft and said clutch providing a second torque flow path between said drive input shaft and said planetary gearset.

3. The fuel pump assembly as set forth in claim 2 wherein said variable drive mechanism further comprises:
a drive input gear rotatably coupled to and carried on said drive input shaft; and
a clutch input gear rotatably coupled to and carried on said input segment of said clutch shaft, said clutch input gear being disposed in meshing engagement with said drive input gear.

4. The fuel pump assembly as set forth in claim 3 wherein said planetary gearset includes a sun gear, at least one pinion gear, and a ring gear.

5. The fuel pump assembly as set forth in claim 4 wherein said variable drive mechanism further comprises:
a clutch output gear rotatably coupled to and carried on said output segment of said clutch shaft, said clutch output gear being disposed in meshing engagement with said ring gear of said planetary gearset.

6. The fuel pump assembly as set forth in claim 1 wherein said planetary gearset includes a sun gear, a plurality of pinion gears disposed in meshing engagement with said sun gear, and a ring gear having a plurality of internal gear teeth disposed in meshing engagement with said plurality of pinion gears and a plurality of external gear teeth that project outwardly from said ring gear.

7. The fuel pump assembly as set forth in claim 6 wherein said variable drive mechanism further comprises:
an electric motor disposed adjacent said planetary gearset having an electric motor output shaft that rotates in response to operation of said electric motor; and
an electric motor output gear rotatably coupled to and carried on said electric motor output shaft that is disposed in meshing engagement with said plurality of external gear teeth of said ring gear.

8. The fuel pump assembly as set forth in claim 6 wherein said variable drive mechanism further comprises:
a brake disposed adjacent said planetary gearset; and
a brake gear rotatably coupled to said brake that is disposed in meshing engagement with said plurality of external gear teeth said ring gear.

9. The fuel pump assembly as set forth in claim 8 wherein said brake gear extends annularly about said ring gear and wherein said brake includes a caliper that is stationarily fixed with respect to said ring gear of said planetary gearset, a rotor having opposing side faces and being rotatably coupled to said brake gear for rotation therewith, a brake actuator disposed adjacent said caliper, and a brake control module operably connected to said brake actuator that controls actuation of said brake actuator, said caliper frictionally engaging said opposing side faces of said rotor to brake rotation of said rotor and said brake gear in response to actuation of said brake actuator.

10. The fuel pump assembly as set forth in claim 8 wherein said brake gear extends annularly about said ring gear and wherein said brake is a band brake including a drum having an outer cylindrical surface and being rotatably coupled to said brake gear for rotation therewith and a brake band that is disposed at least partially about said outer cylindrical surface of said drum and that is stationarily fixed with respect to said ring gear of said planetary gearset, said brake band frictionally engaging said outer cylindrical surface of said drum to brake rotation of said drum and said brake gear in response to actuation of said brake.

11. The fuel pump assembly as set forth in claim 1 wherein said planetary gearset includes a sun gear rotatably coupled to and carried on said drive input shaft.

12. The fuel pump assembly as set forth in claim 11 wherein said planetary gearset includes a plurality of pinion gears supported on a pinion gear carrier, said pinion gear carrier being rotatably coupled to said drive output shaft.

13. The fuel pump assembly as set forth in claim 12 wherein said planetary gearset includes a ring gear having a plurality of internal gear teeth arranged in meshing engagement with said plurality of pinion gears and said ring gear being supported on a ring gear carrier that rotates freely and independent of said drive input shaft and said drive output shaft.

14. The fuel pump assembly as set forth in claim 13 wherein said ring gear carrier defines a pass-through opening receiving one of said drive input shaft and said drive output shaft.

15. The fuel pump assembly as set forth in claim 1 wherein said fuel pump is a non-variable positive displacement liquefied natural gas pump.

16. A variable drive apparatus for coupling with a pump input shaft of a liquefied natural gas pump, said variable drive apparatus comprising:
a drive input shaft for receiving torque from an engine of a vehicle;
a drive output shaft that is rotatably coupled to the pump input shaft; and
a planetary gearset interconnecting said drive input shaft and said drive output shaft to define a first torque flow path, said planetary gearset having a variable gear ratio that varies a rotational speed of said drive output shaft and said pump input shaft relative to a rotational speed of said drive input shaft and the engine.

17. The variable drive apparatus as set forth in claim 16 further comprising:
a clutch shaft spaced from said drive input shaft that includes an input segment that is rotatably coupled to said drive input shaft and an output segment opposite said input segment that is rotatably coupled to said planetary gearset; and
a clutch disposed between and selectively coupling said input segment and said output segment of said clutch shaft such that said input segment of said clutch shaft rotates with said output segment of said clutch shaft, said clutch shaft and said clutch providing a second torque flow path between said drive input shaft and said planetary gearset.

18. The variable drive apparatus as set forth in claim 16 wherein said planetary gearset includes a sun gear, a plurality of pinion gears disposed in meshing engagement with said sun gear, and a ring gear having a plurality of internal gear teeth arranged in meshing engagement with said plurality of pinion gears and a plurality of external gear teeth.

19. The variable drive apparatus as set forth in claim 18 further comprising:
an electric motor disposed adjacent said planetary gearset having an electric motor output shaft that rotates in response to operation of said electric motor; and
an electric motor output gear rotatably coupled to and carried on said electric motor output shaft that is disposed in meshing engagement with said plurality of external gear teeth of said ring gear.

20. The variable drive apparatus as set forth in claim 16 further comprising:
a brake disposed adjacent said planetary gearset; and
a brake gear rotatably coupled to said brake that is disposed in meshing engagement with said plurality of external gear teeth of said ring gear.
